(19) United States
(12) Patent Application Publication
(10) Pub. No.: US 2018/0262081 A1
(43) Pub. Date: Sep. 13, 2018

(54) ELECTRIC MOTOR INCLUDING STATOR ASSEMBLY AND METHOD OF ASSEMBLY THEREOF

(71) Applicant: Regal Beloit America, Inc., Beloit, WI (US)

(72) Inventors: KERRY BAKER SHELTON, Fort Wayne, IN (US); Subhash Marutirao Brahmavar, Fort Wayne, IN (US); Andrew Craig Barry, Fort Wayne, IN (US); Mohamad Khalil Dahouk, Fort Wayne, IN (US); Lester Benjamin Manz, Paulding, OH (US)

(21) Appl. No.: 15/910,223

(22) Filed: Mar. 2, 2018

Related U.S. Application Data
(60) Provisional application No. 62/469,614, filed on Mar. 10, 2017.

(51) Int. Cl. H02K 5/24; H02K 1/02; H02K 1/16; H02K 1/27; H02K 3/12; H02K 7/08; H02K 5/15; H02K 15/03; H02K 15/02; H02K 15/085; H02K 15/14; H01F 1/057

(52) U.S. Cl. CPC H02K 5/24; H02K 1/02; H02K 1/165; H02K 1/276; H02K 3/12; H01F 1/057; H02K 5/15; H02K 15/03; H02K 15/024; H02K 15/085; H02K 15/14; H02K 7/083

(57) ABSTRACT

An electric motor assembly includes a rotor assembly configured to rotate about a central axis and a stator assembly configured to extend about the rotor assembly. The rotor assembly includes at least one of the following: a plurality of spokes and at least one neodymium iron boron magnet. The stator assembly includes an annular body including an inner surface and an outer surface. A first thickness is defined between the inner surface and the outer surface. The stator assembly also includes a plurality of stator teeth extending radially from the annular body and spaced circumferentially about the annular body. Each stator tooth has a second thickness. A ratio of the second thickness to the first thickness is in a range of about 0.5 to about 1. The stator assembly includes no more than 24 slots defined by the plurality of stator teeth.

### CROSS REFERENCE TO RELATED APPLICATION

This application claims priority to U.S. Provisional Patent Application 62/469,614 filed Mar. 10, 2017 and titled “ELECTRIC MOTOR INCLUDING STATOR ASSEMBLY AND METHOD OF ASSEMBLY THEREOF”, which is hereby incorporated by reference in its entirety.

### BACKGROUND

The field of the disclosure relates generally to electric motors, and more specifically, to electric motors that include a stator assembly.

At least some known electric motors include a stator assembly including an annular body and a plurality of teeth extending from the annular body. Typically, the stator assembly is positioned adjacent a rotor assembly. In at least some known electric motors, the rotor assembly produces a magnetic field that interacts with the stator assembly to cause rotation of the rotor assembly relative to the stator assembly. As a result, at least some known stator assemblies are subjected to forces which cause deformation and vibration of the stator assembly during operation. Such vibrations are transferred through the electric motor and generate noise during operation of the electric motor. In addition, some rotor assemblies, such as spoked rotor assemblies, cause increased forces on the stator assemblies.

### BRIEF DESCRIPTION

In one aspect, an electric motor assembly is provided. The electric motor assembly includes a rotor assembly configured to rotate about a central axis and a stator assembly configured to extend about the rotor assembly. The rotor assembly includes at least one of the following: a plurality of spokes and at least one neodymium iron boron magnet. The stator assembly includes an annular body extending about the central axis. The annular body includes an inner surface and an outer surface. The inner surface and the outer surface extend about the central axis and are spaced radially apart. The annular body has a first thickness defined between the inner surface and the outer surface. The stator assembly also includes a plurality of stator teeth extending radially from the annular body and spaced circumferentially about the annular body. Each stator tooth of the plurality of stator teeth has a second thickness. A ratio of the second thickness to the first thickness is in a range of about 0.5 to about 1. The stator assembly further includes a plurality of slots defined by the plurality of stator teeth. The plurality of slots includes no more than 24 slots.

In another aspect, a stator assembly for an electric motor assembly is provided. The stator assembly includes an annular body extending about a central axis. The annular body includes an inner surface and an outer surface. The inner surface and the outer surface extend about the central axis and are spaced radially apart. The annular body has a first thickness defined between the inner surface and the outer surface. The stator assembly is configured to cause rotation of a rotor assembly about a central axis. The rotor assembly includes at least one of the following: a plurality of spokes and at least one neodymium iron boron magnet. The stator assembly includes a plurality of stator teeth extending radially from the annular body and spaced circumferentially about the annular body. Each stator tooth of the plurality of stator teeth has a second thickness. A ratio of the second thickness to the first thickness is in a range of about 0.5 to about 1. The stator assembly further includes a plurality of slots defined by the plurality of stator teeth. The plurality of slots includes no more than 24 slots.

In yet another aspect, a method of assembling an electric motor assembly is provided. The method includes coupling a rotor assembly to a bearing such that the rotor assembly is configured to rotate about a central axis. The rotor assembly includes at least one of the following: a plurality of spokes and at least one neodymium iron boron magnet. The method also includes positioning a stator assembly along the central axis. The stator assembly includes a plurality of stator teeth and an annular body extending about the central axis. The annular body includes an inner surface and an outer surface. The inner surface and the outer surface extend about the central axis and are spaced radially apart. The annular body has a first thickness defined between the inner surface and the outer surface. The method further includes positioning the stator assembly adjacent the rotor assembly such that the plurality of stator teeth are spaced about the rotor assembly. The plurality of stator teeth extend radially from the annular body and are spaced circumferentially about the annular body. Each stator tooth of the plurality of stator teeth has a second thickness. A ratio of the second thickness to the first thickness is in a range of about 0.5 to about 1. The method further includes positioning a plurality of conduction coils about the plurality of stator teeth. Each conduction coil is coupled to one stator tooth of the plurality of stator teeth.

### BRIEF DESCRIPTION OF THE DRAWINGS

FIG. 1 is a perspective view of an exemplary electric motor assembly;

FIG. 2 is a schematic sectional view of the electric motor assembly shown in FIG. 1;

FIG. 3 is an end view of a stator assembly and a rotor assembly of the electric motor assembly shown in FIGS. 1 and 2;

FIG. 4 is an enlarged end view of a portion of the stator assembly shown in FIG. 3; and

FIG. 5 is a perspective view of an alternative rotor assembly for the electric motor assembly shown in FIGS. 1 and 2.

Although specific features of various embodiments may be shown in some drawings and not in others, this is for convenience only. Any feature of any drawing may be referenced and/or claimed in combination with any feature of any other drawing.

### DETAILED DESCRIPTION

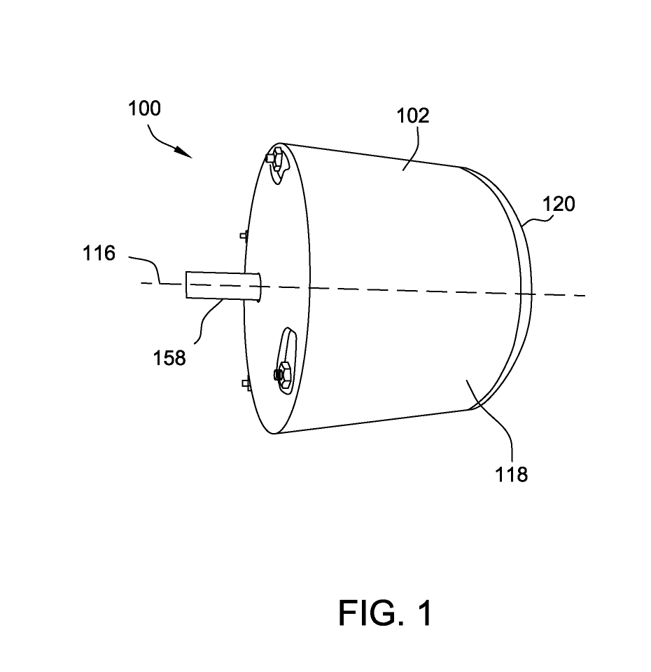

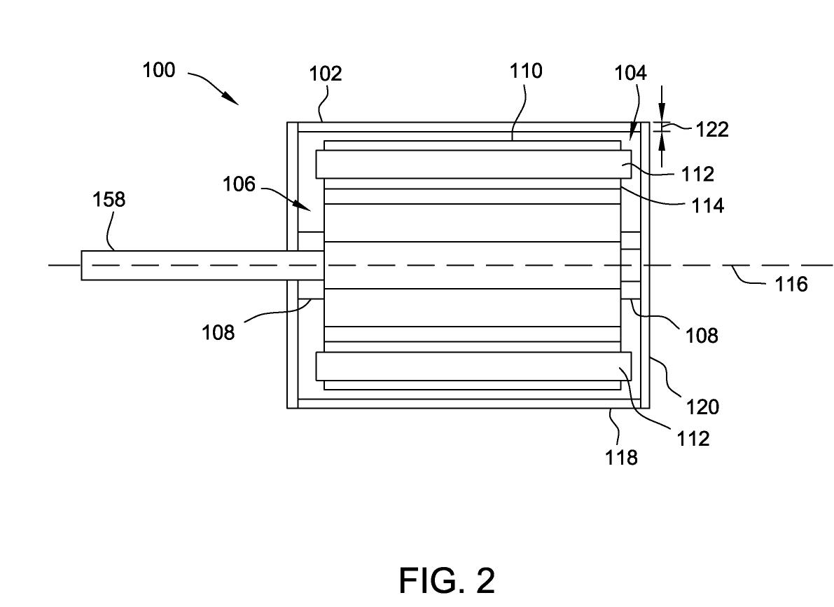

FIG. 1 is a perspective view an exemplary electric motor assembly 100. FIG. 2 is a sectional view of motor assembly 100. In the exemplary embodiment, motor assembly 100 includes a housing 102, a stator assembly 104, and a rotor assembly 106. Stator assembly 104 includes a magnetic stator core 110 and a plurality of conduction coils 112. Each conduction coil 112 is coupled to one of a plurality of stator teeth 114. In some embodiments, motor assembly 100 includes one conduction coil 112 per stator tooth 114. In operation, rotor assembly 106 is positioned adjacent stator assembly 104 and a voltage is applied to conduction coils 112 in sequence to cause rotation of rotor assembly 106 about a central axis 116. Stator assembly 104 extends about rotor assembly 106. Bearings 108 support rotor assembly 106 and allow rotor assembly 106 to rotate relative to stator assembly 104. In alternative embodiments, motor assembly 100 has any configuration that enables motor assembly 100 to operate as described herein.

In the exemplary embodiment, housing 102 includes a shell 118 and an end shield 120. Shell 118 and end shield 120 enclose stator assembly 104 and are configured to support stator assembly 104. In particular, end shield 120 is coupled to an end of stator assembly 104. Shell 118 is positioned about stator assembly 104 and is coupled to an outer edge of end shield 120. End shield 120 is a circular plate and extends continuously across an end of shell 118. At least one of shell 118 and end shield 120 may be substantially solid and free from openings. In the exemplary embodiment, both shell 118 and end shield 120 are substantially solid and free from openings. As a result, housing 102 provides support to stator assembly 104. In particular, housing 102 reduces deformation of stator assembly 104 and reduces transmission of vibrations during operation of motor assembly 100. In alternative embodiments, motor assembly 100 includes any housing 102 that enables motor assembly 100 to operate as described herein. For example, in some embodiments, shell 118 and/or end shield 120 includes at least one opening.

Also, in the exemplary embodiment, shell 118 is a cylinder and extends about central axis 116. Shell 118 has a thickness 122 configured to provide support and reduce vibrations in motor assembly 100. For example, in some embodiments, thickness 122 is in a range of about 1.5 mm to about 10 mm. In alternative embodiments, housing 102 includes any shell 118 that enables motor assembly 100 to operate as described herein.

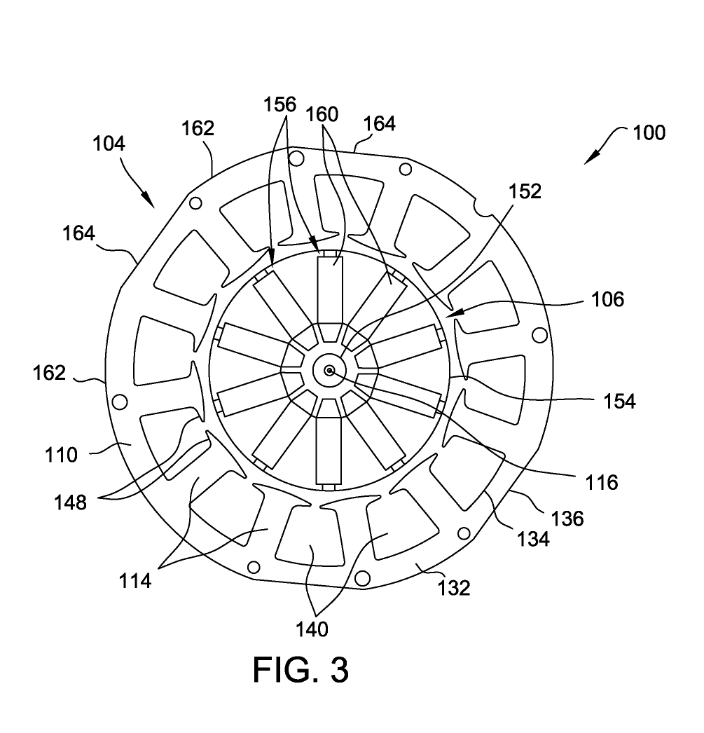

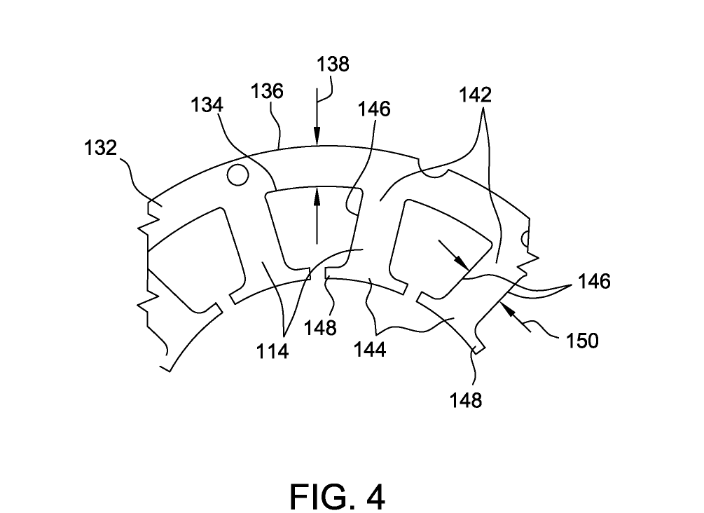

FIG. 3 is an end view of stator assembly 104 and rotor assembly 106 of motor assembly 100. FIG. 4 is an enlarged end view of a portion of stator assembly 104 including stator teeth 114. Stator assembly 104 includes an annular body or backplane 132 extending about central axis 116. Annular body 132 includes an inner surface 134 and an outer surface 136. Inner surface 134 and outer surface 136 extend about central axis 116 and are spaced radially apart. Inner surface 134 and outer surface 136 define a thickness 138 of annular body 132 therebetween. In some embodiments, thickness 138 is at least about 8 mm. In further embodiments, thickness 138 is in a range of about 8 millimeters (mm) to about 20 mm. In alternative embodiments, stator assembly 104 includes any annular body 132 that enables motor assembly 100 to operate as described herein.

Also, in the exemplary embodiment, stator assembly 104 has an outer diameter defined by annular body 132. In some embodiments, the outer diameter is in a range of about 100 mm (4 inches (in.)) to about 200 mm (8 in.). For example, in some embodiments, annular body 132 has an outer diameter of approximately 140 mm (5.5 in.) or approximately 165 mm (6.5 in.). In alternative embodiments, stator assembly 104 has any diameter that enables motor assembly 100 to operate as described herein.

In the exemplary embodiment, stator assembly 104 is configured to resist hoop stress and resist deformation during operation of motor assembly 100. As used herein, the term “hoop stress” refers to a force in a circumferential direction. For example, thickness 138 facilitates annular body 132 having an increased hoop stress capacity. As a result, the vibrations of stator assembly 104 are reduced. Accordingly, motor assembly 100 generates less noise during operation than at least some known motor assemblies.

Also, in the exemplary embodiment, stator teeth 114 extend radially from annular body 132. In some embodiments, stator teeth 114 are integral with annular body 132. In further embodiments, stator teeth 114 are coupled to annular body 132. In the exemplary embodiment, each stator tooth 114 includes a proximal end 142, a distal end 144, side surfaces 146, and tips 148. Proximal ends 142 are adjacent inner surface 134. Distal ends 144 are opposite proximal ends 142. Side surfaces 146 extend between proximal ends 142 and distal ends 144. Side surfaces 146 define a tooth thickness 150 therebetween. In some embodiments, tooth thickness 150 is in a range of about 1 mm to about 9 mm.

In addition, in the exemplary embodiment, stator teeth 114 are spaced circumferentially about annular body 132 and define slots 140 therebetween. Stator teeth 114 are configured to receive conduction coils 112 such that conduction coils 112 extend about side surfaces 146 and through slots 140. In some embodiments, stator teeth 114 define no more than 24 slots. In the exemplary embodiment, stator assembly 104 includes twelve stator teeth 114 defining twelve slots 140. In alternative embodiments, motor assembly 100 includes any stator teeth 114 that enable motor assembly 100 to operate as described herein.

Moreover, in the exemplary embodiment, stator teeth 114 and annular body 132 are configured to reduce vibrations and resist deformation of stator assembly 104 during operation of motor assembly 100. For example, thickness 138 of annular body 132 and tooth thickness 150 are balanced to provide magnetic flux capacity and hoop stress capacity. In particular, thickness 138 is greater than thicknesses of at least some known stator assemblies and tooth thickness 150 is less than the thickness of at least some known teeth. As a result, stator assembly 104 resists deformation and vibrates less than at least some known stator assemblies. In the exemplary embodiment, a ratio of thickness 150 of stator teeth 114 to thickness 138 of annular body 132 is in a range of about 0.5 to about 1. In alternative embodiments, annular body 132 and stator teeth 114 have any configuration that enables motor assembly 100 to operate as described herein.

In some embodiments, stator assembly 104 is assembled from a plurality of laminations. Each of the plurality of laminations is formed in a desired shape and thickness. The laminations are coupled together to form stator assembly 104 having the desired cumulative thickness. In further embodiments, stator assembly 104 includes a first configuration, e.g., a flat or strip configuration, and a second configuration, e.g., a round configuration. Stator assembly 104 is moved or “rolled” from the first configuration to the second configuration to form a roll-up stator assembly 104 having a substantially cylindrical shape. In alternative embodiments, stator assembly 104 is assembled in any manner that enables stator assembly 104 to function as described herein.

In reference to FIG. 3, rotor assembly 106 includes a middle portion 152, a rim 154, and a plurality of spokes 156. A rotatable shaft 158 extends from middle portion 152 and is configured to couple to a load. Spokes 156 extend between middle portion 152 and rim 154. Spokes 156 include magnets 160 that form poles of rotor assembly 106. Accordingly, in the exemplary embodiment, rotor assembly 106 is a spoked rotor and is configured to provide increased magnetic flux in comparison to at least some known rotor assemblies. Stator assembly 104 is configured to provide increased capacities for the increased magnetic flux and the increased hoop stress due to the increased magnetic flux. In alternative embodiments, motor assembly 100 includes any rotor assembly 106 that enables motor assembly 100 to operate as described herein. For example, in some embodiments, rotor assembly 106 includes at least one permanent magnet such as a neodymium iron boron magnet that is configured to provide increased magnetic flux in comparison to at least some known rotor assemblies.

Also, in the exemplary embodiment, outer surface 136 includes curved portions 162 and straight portions 164. Curved portions 162 extend circumferentially about annular body 132. Straight portions 164 extend along chords between curved portions 162. In addition, curved portions 162 and straight portions 164 extend longitudinally relative to central axis 116 from a first end to a second end of annular body 132. Curved portions 162 provide increased strength to annular body 132 to increase hoop stress capacity and resist deformation of annular body 132. In alternative embodiments, outer surface 136 includes any portion that enables motor assembly 100 to operate as described herein. For example, in some embodiments, outer surface 136 is curved about the entire periphery of annular body 132.

In reference to FIGS. 2 and 3, a method of assembling motor assembly 100 includes coupling rotor assembly 106 to bearings 108 such that rotor assembly 106 is configured to rotate about central axis 116. The method also includes positioning stator assembly 104 along central axis 116 and adjacent rotor assembly 106. Stator assembly 104 and rotor assembly 106 are aligned such that magnetic fields extend between stator teeth 114 and magnets 160. In some embodiments, the method includes enclosing stator assembly 104 in housing 102 and coupling stator assembly 104 to end shield 120. In further embodiments, the method includes positioning shell 118 about stator assembly 104 and coupling end shield 120 to shell 118. In some embodiments, the method includes positioning rotor assembly 106 within stator assembly 104 such that stator teeth 114 of stator assembly 104 are spaced about rotor assembly 106 and extend radially relative to rotor assembly 106.

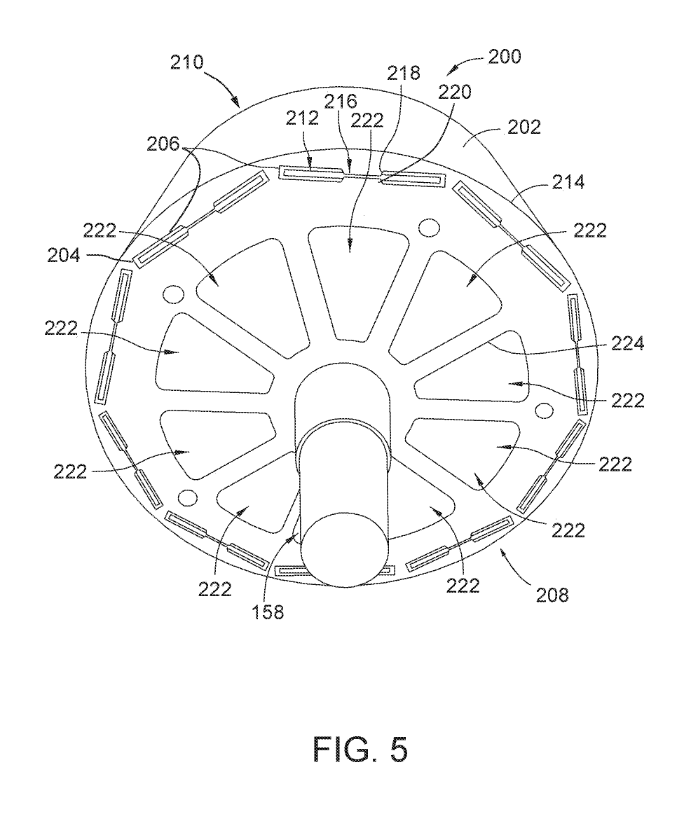

FIG. 5 is a perspective view of an alternative rotor assembly 200 for electric motor assembly 100 (shown in FIG. 1). Rotor assembly 200 includes a rotor core 202. A rotatable shaft 158 extends from rotor core 202 and is configured to couple to a load. In some embodiments, rotor core 202 includes a plurality of laminations coupled together. In further embodiments, rotor core 202 includes a solid rotor core. In alternative embodiments, rotor assembly 200 includes any rotor core 202 that enables rotor assembly 200 to function as described herein.

In the exemplary embodiment, rotor core 202 further includes a plurality of inner walls 204 that define a plurality of permanent magnet openings 206. For example, each permanent magnet opening is defined by four inner walls 204. In the exemplary embodiment, rotor core 202 includes ten permanent magnet openings 206. The plurality of permanent magnet openings 206 extend from a first end 208, through rotor core 202, to a second end 210. Each of the plurality of permanent magnet openings 206 is configured to receive a permanent magnet 212. Permanent magnet 212 extends at least partially from first end 208 to second end 210 of rotor core 202. Adjacent permanent magnets 212 within the plurality of openings 206 are oppositely polarized. Although described as including ten permanent magnet openings 206 and permanent magnets 212, rotor core 202 may include any number of permanent magnet openings and permanent magnets that allow electric motor assembly 100 (shown in FIG. 1) to operate as described herein. Examples of motors that may include interior permanent magnet rotors include, but are not limited to, electronically commutated motors (ECMs). ECMs may include, but are not limited to, brushless direct current (BLDC) motors, brushless alternating current (BLAC) motors, and variable reluctance motors.

Also, in the exemplary embodiment, a first rotor end lamination 214 of rotor assembly 200 is coupled to rotor core 202 and includes first permanent magnet retention feature 216. For example, tabs 218 and 220 within first rotor end lamination 214 secure permanent magnet 212 within permanent magnet opening 206 of rotor core 202. In the exemplary embodiment, rotor assembly 200 also includes a plurality of inner rotor walls 224 that define a plurality of rotor core openings 222. In the exemplary embodiment, rotor core 202 includes ten rotor core openings 222. Although described as including ten rotor core openings 222, rotor assembly 200 may include any number of rotor core openings that allow rotor assembly 200 to function as described herein. The plurality of rotor core openings 222 extend through first rotor end lamination 214, rotor core 202 and, if included in rotor assembly 200, through a second rotor end lamination.

In addition, in the exemplary embodiment, permanent magnets 212 are configured to provide increased magnetic flux in comparison to at least some known rotor assemblies. For example, in some embodiments, permanent magnets 212 include a rare earth metal such as, without limitation, neodymium, terbium, dysprosium, lanthanum, and cerium. In the exemplary embodiment, at least one of permanent magnets 212 is a neodymium iron boron magnet. In alternative embodiments, rotor assembly 200 includes any permanent magnets 212 that enable electric motor assembly 100 (shown in FIG. 1) to operate as described herein.

The apparatus, methods, and systems described herein provide a stator assembly of an electric motor. The stator assembly is configured to reduce vibrations and noise of the electric motor during operation. For example, embodiments of the stator assembly include an annular body that has an increased thickness in comparison to at least some known stator assemblies. In addition, in some embodiments, an outer surface of the annular body includes curved portions. As a result, the stator assembly is stiffer, i.e., has an increased resistance to deformation, and the electric motor generates less noise during operation than at least some known electric motors.

In addition, some embodiments of the electric motor include a housing that encloses the stator assembly and provides increased stiffness to the stator assembly. For example, some embodiments of the housing include a shell and an end shield that are substantially solid, e.g., free from vents, and resist movement and/or deformation of the stator assembly.

Exemplary embodiments of an electric motor assembly are described above in detail. The electric motor assembly and its components are not limited to the specific embodiments described herein, but rather, components of the systems may be utilized independently and separately from other components described herein. For example, the components may also be used in combination with other machine systems, methods, and apparatuses, and are not limited to practice with only the systems and apparatus as described herein. Rather, the exemplary embodiments can be implemented and utilized in connection with many other applications.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An electric motor assembly comprising:
a rotor assembly configured to rotate about a central axis, wherein said rotor assembly includes at least one of the following: a plurality of spokes and at least one neodymium iron boron magnet; and
a stator assembly configured to extend about said rotor assembly, said stator assembly comprising:
an annular body extending about the central axis, said annular body including an inner surface and an outer surface, wherein said inner surface and said outer surface extend about the central axis and are spaced radially apart, said annular body having a first thickness defined between said inner surface and said outer surface;
a plurality of stator teeth extending radially from said annular body and spaced circumferentially about said annular body, each stator tooth of said plurality of stator teeth having a second thickness, wherein a ratio of said second thickness to said first thickness is in a range of about 0.5 to about 1; and
a plurality of slots defined by said plurality of stator teeth, wherein said plurality of slots comprises no more than 24 slots.

2. The electric motor assembly in accordance with claim 1, wherein the first thickness is at least about 8 millimeter (mm), and an outer diameter of said annular body is approximately 140 mm.

3. The electric motor assembly in accordance with claim 2, wherein the second thickness is less than about 9 mm.

4. The electric motor assembly in accordance with claim 1 further comprising a housing coupled to said stator assembly and configured to enclose said stator assembly, said housing including a shell and an end shield coupled to said shell, wherein said shell and said end shield are substantially solid.

5. The electric motor assembly in accordance with claim 4, wherein said shell has a thickness of at least about 1.5 mm.

6. The electric motor assembly in accordance with claim 4, wherein said end shield includes a plate extending across an end of said shell.

7. The electric motor assembly in accordance with claim 1, wherein each stator tooth of said plurality of stator teeth includes an end and a pair of side surfaces extending from said inner surface to said end, wherein said pair of side surfaces define the second thickness therebetween.

8. The electric motor assembly in accordance with claim 7, wherein each stator tooth of said plurality of stator teeth is configured to receive a conduction coil such that the conduction coil extends about said pair of side surfaces and through the plurality of slots.

9. The electric motor assembly in accordance with claim 8, wherein said rotor assembly provides a magnetic flux that interacts with said stator assembly such that said rotor assembly rotates when voltage is applied to the conduction coils.

10. The electric motor assembly in accordance with claim 1, wherein said outer surface includes at least one curved portion extending at least partially about the central axis.

11. A stator assembly for an electric motor assembly, said stator assembly comprising:
an annular body extending about a central axis, said annular body including an inner surface and an outer surface, wherein said inner surface and said outer surface extend about the central axis and are spaced radially apart, said annular body having a first thickness defined between said inner surface and said outer surface, wherein said stator assembly is configured to cause rotation of a rotor assembly about a central axis, wherein the rotor assembly includes at least one of the following: a plurality of spokes and at least one neodymium iron boron magnet;
a plurality of stator teeth extending radially from said annular body and spaced circumferentially about said annular body, each stator tooth of said plurality of stator teeth having a second thickness, wherein a ratio of the second thickness to said first thickness is in a range of about 0.5 to about 1; and
a plurality of slots defined by said plurality of stator teeth, wherein said plurality of slots comprises no more than 24 slots.

12. The stator assembly in accordance with claim 11, wherein the first thickness is at least about 8 millimeters (mm), and an outer diameter of said annular body is approximately 140 mm.

13. The stator assembly in accordance with claim 12, wherein the second thickness is less than about 9 mm.

14. The stator assembly in accordance with claim 11, wherein each stator tooth of said plurality of stator teeth includes an end and a pair of side surfaces extending from said inner surface to said end, wherein said pair of side surfaces define the second thickness therebetween, each stator tooth of said plurality of stator teeth configured to receive a conduction coil such that the conduction coil extends about said pair of side surfaces and through the plurality of slots.

15. A method of assembling an electric motor assembly, said method comprising:
coupling a rotor assembly to a bearing such that the rotor assembly is configured to rotate about a central axis, wherein the rotor assembly includes at least one of the following: a plurality of spokes and at least one neodymium iron boron magnet;
positioning a stator assembly along the central axis, the stator assembly including a plurality of stator teeth and an annular body extending about the central axis, the annular body including an inner surface and an outer surface, wherein the inner surface and the outer surface extend about the central axis and are spaced radially apart, the annular body having a first thickness defined between the inner surface and the outer surface;
positioning the stator assembly adjacent the rotor assembly such that the plurality of stator teeth are spaced about the rotor assembly, wherein the plurality of stator teeth extend radially from the annular body and are spaced circumferentially about the annular body, each stator tooth of said plurality of stator teeth having a second thickness, wherein a ratio of the second thickness to the first thickness is in a range of about 0.5 to about 1; and
positioning a plurality of conduction coils about the plurality of stator teeth, wherein each conduction coil of the plurality of conduction coils is coupled to one stator tooth of the plurality of stator teeth.

16. The method in accordance with claim 15 further comprising coupling a housing to the stator assembly to enclose the stator assembly, the housing including a shell and an end shield, wherein the shell and the end shield are substantially solid.

17. The method in accordance with claim 16, further comprising positioning the shell about the stator assembly, wherein the shell has a thickness of at least about 1.5 mm.

18. The method in accordance with claim 16, further comprising coupling an end shield to the shell, wherein the end shield includes a plate configured to extend across an end of the shell.

19. The method in accordance with claim 15, wherein positioning a plurality of conduction coils about the plurality of stator teeth comprises positioning the plurality of conduction coils such that the conduction coils extend about side surfaces of each stator tooth and through a plurality of slots defined between stator teeth.

20. The method in accordance with claim 19 further comprising positioning the rotor assembly within the stator assembly, wherein the rotor assembly provides a magnetic flux that interacts with the stator assembly such that the rotor assembly rotates when voltage is applied to the conduction coils.
